(19) United States
(12) Patent Application Publication
(10) Pub. No.: US 2025/0173271 A1
(43) Pub. Date: May 29, 2025

(54) ARTIFICIAL NEURAL NETWORK FOR IMPROVING CACHE PREFETCHING PERFORMANCE IN COMPUTER MEMORY SUBSYSTEM

(71) Applicant: InnoGrit Technologies Co., Ltd., Shanghai (CN)

(72) Inventors: Chenrong Xiong, San Jose, CA (US); Bo Fu, Cupertino, CA (US)

(21) Appl. No.: 18/908,608

(22) Filed: Oct. 7, 2024

Related U.S. Application Data
(60) Provisional application No. 63/602,411, filed on Nov. 23, 2023.

(51) Int. Cl. G06F 12/0862

(52) U.S. Cl. CPC G06F 12/0862

(57) ABSTRACT

A controller is configured to generate M sets of data prefetching parameters using an artificial neural network based on a current data request for data from a non-volatile memory, with M being a positive integer, select N sets from the M sets, with N being a non-negative integer not greater than M, retrieve data from the non-volatile memory based on the N sets, and prefetch to a cache prefetch data which is a part or all of the retrieved data. At least an input of inputs to the artificial neural network in generating the M sets is (A) a current LDA (logical data unit address) section ID (identification) of an LDA section that contains a part or all of the data requested by the current data request or (B) a memory read latency of the non-volatile memory.

### CROSS-REFERENCE TO RELATED APPLICATIONS

This application claims priority to U.S. Provisional Application No. 63/602,411, filed on Nov. 23, 2023, the entire disclosure of which is hereby incorporated by reference.

### BACKGROUND

Cache prefetching helps reduce the latency in accessing data by proactively fetching data from the memory to the cache before it is actually needed by the host (e.g., a processor). By accurately predicting data access patterns and prefetching the required data to the cache, the processor can significantly reduce the time spent waiting for data, thus speeding up the execution of instructions. This can lead to improved overall system performance, reduced memory access latency, and increased throughput.

### SUMMARY

Disclosed herein is a controller configured to: generate M sets of data prefetching parameters using an artificial neural network based on a current data request for data from a non-volatile memory, with M being a positive integer, select N sets from the M sets, with N being a non-negative integer not greater than M, retrieve data from the non-volatile memory based on the N sets, and prefetch to a cache prefetch data which is a part or all of the retrieved data. At least an input of the inputs to the artificial neural network in generating the M sets is (A) a current LDA (logical data unit address) section ID (identification) of an LDA section that contains a part or all of the data requested by the current data request or (B) a memory read latency of the non-volatile memory.

Each set of the M sets of data prefetching parameters may include a predicted starting LBA (Logical Block Address) and a predicted I/O (input/output) size.

M and N may both equal 1.

M may be greater than 1, and the controller may be configured to select the N sets from the M sets by: causing the artificial neural network to generate for each set of the M sets a cache hit probability of data corresponding to said each set being requested by a future data request; and selecting sets of the M sets whose cache hit probabilities exceed a pre-specified probability threshold resulting in the N sets being selected from the M sets.

The controller may be configured to implement the artificial neural network in generating the M sets of data prefetching parameters.

The non-volatile memory may be a flash memory.

The artificial neural network may be a feed-forward neural network, a reinforcement learning network, a long short-term memory network, a recurrent neural network, a transformer model, or any combinations thereof.

The controller may be on a single semiconductor die.

The inputs to the artificial neural network may be selected from a group consisting of: a current application ID of an application that makes the current data request, the current LDA section ID, a current starting LBA of the data requested by the current data request, a current I/O size of the data requested by the current data request, the memory read latency of the non-volatile memory, and any combinations thereof.

The inputs to the artificial neural network may be selected from a group consisting of: a current application ID of an application that makes the current data request, the current LDA section ID, a current starting LBA of the data requested by the current data request, a current I/O size of the data requested by the current data request, the memory read latency of the non-volatile memory, a zone ID associated with the current data request, a placement identifier associated with the current data request, a namespace ID associated with the current data request, and any combinations thereof.

The controller may include an LBA to LDA converter configured to convert an LBA into an LDA of the non-volatile memory; and an LDA to PDA (physical data address) converter configured to convert an LDA into a PDA of the non-volatile memory.

The controller may be configured to determine if the cache contains data requested by the current data request.

An LDA space of the non-volatile memory may include non-overlapping LDA sections of different sizes.

The cache may be part of a solid-state drive (SSD) that includes the controller.

The cache may be part of the controller.

The controller may be a part of a solid-state drive (SSD), a flash drive, a mother board, a processor, a computer, a server, a gaming device, or a mobile device.

A method of using the controller may include generating the M sets of data prefetching parameters with the controller using the artificial neural network based on the current data request for data from the non-volatile memory; selecting the N sets from the M sets; retrieving data from the non-volatile memory based on the N sets; and prefetching to the cache prefetch data which is a part or all of the retrieved data. At least an input of inputs to the artificial neural network in generating the M sets is (A) a current LDA section ID of an LDA section that contains a part or all of the data requested by the current data request or (B) a memory read latency of the non-volatile memory.

### BRIEF DESCRIPTION OF FIGURES

FIG. 1 schematically shows a computer system, according to an embodiment.

FIG. 2 shows a diagram for memory access, according to an embodiment.

FIG. 3 and FIG. 4 show diagrams of cache operation, according to different embodiments.

FIG. 5 shows a flowchart generalizing the cache prefetching operation, according to an embodiment.

### DETAILED DESCRIPTION

### Computer System 100

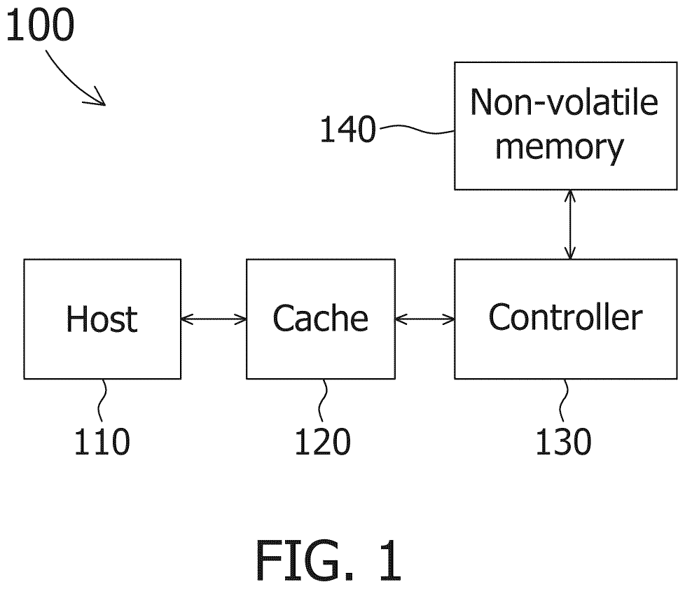

FIG. 1 schematically shows a computer system 100, according to an embodiment. The computer system 100 may include a host 110 (e.g., a processor), a cache 120, a controller 130, and a non-volatile memory 140.

### Cache 120

The cache 120 may operate as a high-speed access layer between the host 110 and the memory subsystem 130+140 including the controller 130 and the non-volatile memory 140.

### Controller 130

The controller 130 may manage the flow of data between the non-volatile memory 140 and the host 110, ensuring efficient and timely access to stored information. The controller 130 may coordinate the reading and writing of data to and from the non-volatile memory 140, translating data requests by the host 110 into memory operations. The controller 130 may implement caching, cache prefetching, and pipelining. The controller 130 may perform error detection and correction, power management, and overall system stability.

Note that in the present patent application, “data” means information stored or to be stored in the non-volatile memory 140 and/or instructions to the controller 130.

The controller 130 may be a part of a solid-state drive (SSD), a flash drive, a mother board, a processor, a computer, a server, a gaming device, or a mobile device (not shown).

The cache 120 may be a part of the solid-state drive (SSD) that includes the controller 130. The cache 120 may be a part of the controller 130.

The controller 130 may be formed on a single semiconductor die.

### Non-Volatile Memory 140

The non-volatile memory 140 may be a flash memory. A flash memory is a non-volatile storage device that retains data even when power is removed. Flash memory technology utilizes floating-gate transistors or charge trap technology to store data.

### LBA, LDA, and PDA in Memory Access

An LBA (Logical Block Address) may be used by the host 110 to specify the logical address of a data block, which could be 64 bytes, 128 bytes, 256 bytes, or 512 bytes of data stored in the non-volatile memory 140. However, to improve the performance, a data unit in the non-volatile memory 140 may be 256 bytes, 512 bytes, 1K bytes, 2K bytes, 4K bytes, or even larger. Therefore, an LDA (Logical Data Unit Address) may be used to specify the logical address of a data unit in the non-volatile memory 140. So, there is a size mismatch between the data block used by the host 110 and the data unit used by the non-volatile memory 140.

To access the physical cells of the non-volatile memory 140 for reading/writing a data unit, a PDA (Physical Data Address) may be used to specify the physical address of the data unit in the non-volatile memory 140.

For a read command from the host 110 to read a data block, the controller 130 may convert the LBA of the data block to LDA, and then convert the LDA to PDA by looking up a table (not shown) to retrieve a data unit from the non-volatile memory 140.

After retrieving the data unit associated with the LBA from the non-volatile memory 140, since the retrieved data unit consists of multiple data blocks, the controller 130 may use the LBA to extract the requested data block from the retrieved data unit.

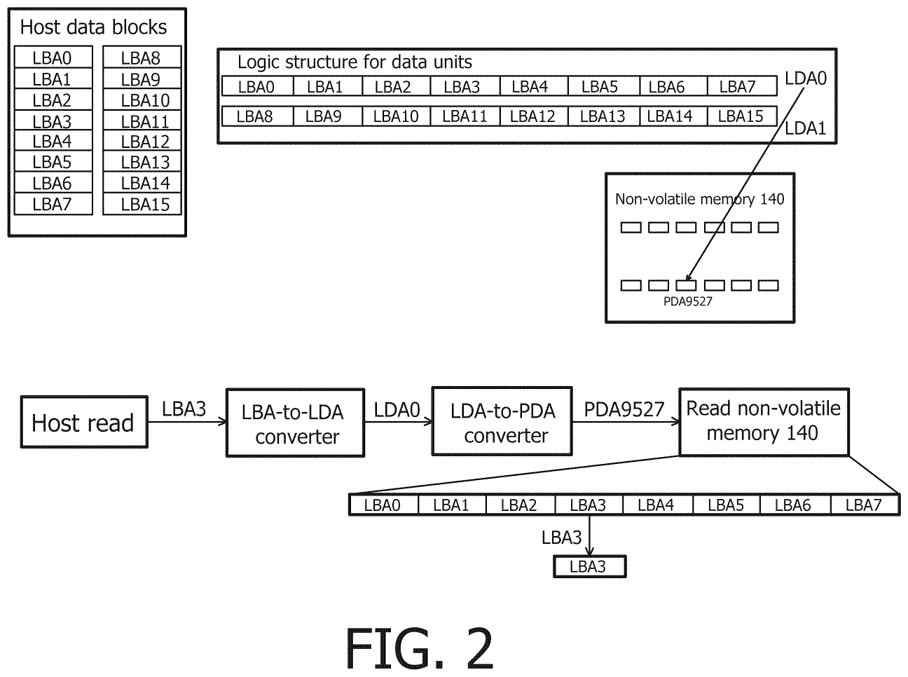

As an example, with reference to FIG. 1 and FIG. 2, the host 110 requests a data block with logical address LBA3 (i.e., I/O (input/output) size is 1 data block). Assume that the requested data is not in the cache 120. In response, the controller 130 (A) converts LBA3 to LDA0 using an LBA-to-LDA converter, and (B) converts LDA0 to physical address PDA9527 using an LDA-to-PDA converter. Then, the controller 130 retrieves from the non-volatile memory 140 a data unit at physical address PDA9527. Then, the controller 130 extracts a data block from the retrieved data unit based on LBA3 and sends the extracted data block to the host 110.

### LDA Sections in Memory Access

The LDA space may be divided into non-overlapping LDA sections each of which may be assigned a unique LDA-section ID (identification). For example, with reference to FIG. 2, the data unit (8 data blocks) at logical address LDA0 may be an LDA section, and the data unit (8 data blocks) at logical address LDA1 may be another LDA section. An LDA section may contain at least one LDA address.

The controller 130 may convert LBAs from the host 110 to LDAs to access storage spaces within a specific LDA section.

The controller 130 may group data from applications with similar I/O behaviors into the same LDA section. This minimizes the write amplification factor and enhances system performance.

The non-overlapping LDA sections may have the same size or different sizes.

### Caching Operation

With reference to FIG. 1-FIG. 3, when the host 110 requests for data in the non-volatile memory 140 (called a current data request), the host 110 may specify to the controller 130 (A) the current starting LBA of the requested data (LBA3 in the example above), and (B) the current I/O size of the requested data (1 data block in the example above).

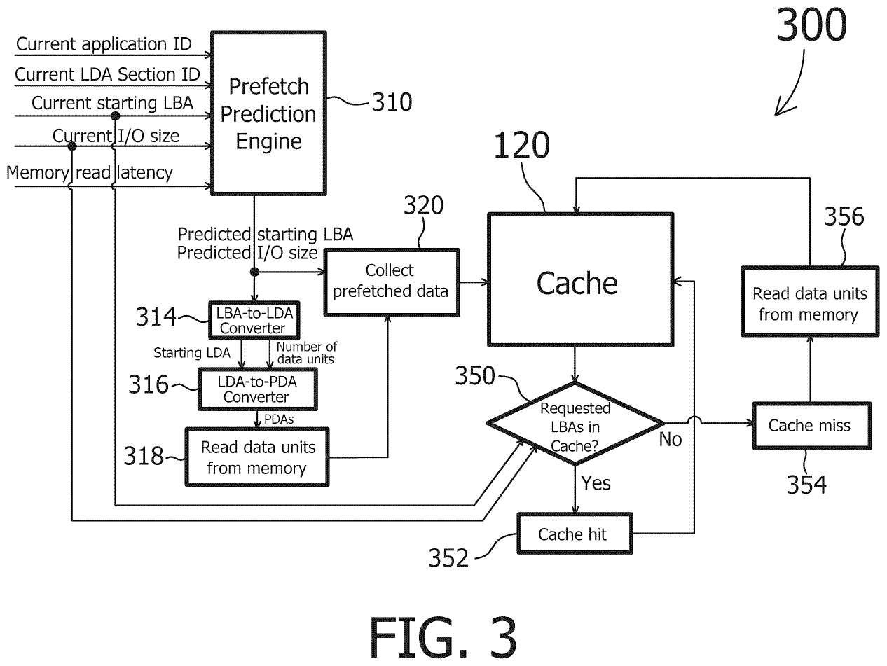

In response, the controller 130 may use the current starting LBA and the current I/O size to check the cache 120 (see the 2 arrows going to box 350 from southwest in FIG. 3).

If the requested data is found in the cache 120 (a cache hit, box 352 in FIG. 3), the requested data may be sent from the cache 120 to the host 110.

If the requested data is not found in the cache 120 (a cache miss, box 354 in FIG. 3), the controller 130 may (A) retrieve the requested data (in form of data unit(s), box 356 in FIG. 3) from the non-volatile memory 140 (1 data unit at PDA9527 in the example above), (B) extract the requested data from the retrieved data unit(s), (C) send the requested data to the host 110, and (D) storing a copy of the retrieved data unit(s) in the cache 120 for potential future use (see the arrow going to the cache 120 from box 356 in FIG. 3).

### Cache Prefetching Operation

The controller 130 may perform cache prefetching to improve the cache hit rate by predicting the data or instructions that are likely to be needed in the near future and bringing them from the non-volatile memory 140 into the cache 120 proactively.

Specifically, with reference to FIG. 1-FIG. 3, when the host 110 requests for data in the non-volatile memory 140 (i.e., the current data request), the host 110 may specify to the controller 130 the following:
(i) the current starting LBA of the requested data (LBA3 in the example above),
(ii) the current I/O size of the requested data (1 data block in the example above), and
(iii) the current application ID (identification) which is the ID of the application that makes the current data request.

In response, the controller 130 may send to a prefetch prediction engine 310 the following inputs (as shown in FIG. 3):
(A) the current application ID,
(B) the current LDA section ID (i.e., the ID of the LDA section that contains a part or all of the data requested by the current data request),
(C) the current starting LBA (i.e., the LBA of the starting data block of the data requested by the current data request),
(D) the current I/O size (i.e., the size of the data requested by the current data request), and
(E) the memory read latency of the non-volatile memory 140 (i.e., the amount of time it takes to retrieve data from the non-volatile memory 140 after a read request is initiated).

The prefetch prediction engine 310 may use an artificial neural network (not shown) to generate a predicted starting LBA and a predicted I/O size of the data to be prefetched to the cache 120 based on the inputs (A), (B), (C), (D), and (E) mentioned above. Specifically, the artificial neural network may receive as inputs the inputs (A), (B), (C), (D), and (E) mentioned above and generate as outputs the predicted starting LBA and the predicted I/O size based on the inputs (A), (B), (C), (D), and (E).

Next, the controller 130 may retrieve (i.e., read) data unit(s) in the non-volatile memory 140 based on the predicted starting LBA and the predicted I/O size using an LBA-to LDA converter 314 and an LDA-to-PDA converter 316 (see box 318 in FIG. 3).

Next, the controller 130 may prefetch to the cache 120 (A) the retrieved data unit(s), or (B) a part of the retrieved data unit(s) which is the predicted requested data based on the predicted starting LBA and the predicted I/O size (see box 320 in FIG. 3).

### Artificial Neural Network

The artificial neural network used by the prefetch prediction engine 310 in generating the predicted starting LBA and predicted I/O size may include an input layer, hidden layers, and an output layer, with the input layer receiving as inputs the inputs (A), (B), (C), (D), and (E) mentioned above, and the output layer generating as outputs the predicted starting LBA and the predicted I/O size.

The artificial neural network may be a feed-forward neural network, a reinforcement learning network, a long short-term memory network, a recurrent neural network, a transformer model, or any combinations thereof.

With reference to FIG. 1-FIG. 4, the prefetch prediction engine 310 may be part of the controller 130. As a result, the controller 130 implements the artificial neural network.

### Alternative Embodiments for Cache Prefetching

In the embodiments described above, with reference to FIG. 1-FIG. 3, the prefetch prediction engine 310 uses the artificial neural network to generate a single set of 2 data prefetching parameters: the predicted starting LBA and the predicted I/O size.

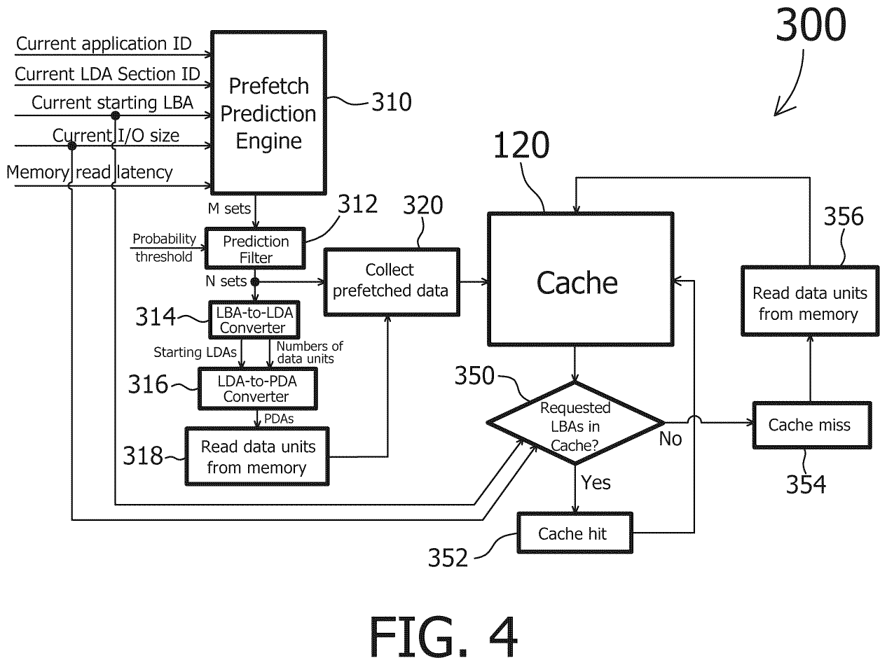

In an alternative embodiment, with reference to FIG. 4, the prefetch prediction engine 310 may use the artificial neural network to generate M sets of data prefetching parameters based on the inputs (A), (B), (C), (D), and (E), with M being an integer greater than 1 (see box 310 in FIG. 4).

Next, the controller 130 may select N sets from the M sets, with N being a non-negative integer not greater than M (see box 312 in FIG. 4).

Next, if N>0, the controller 130 may retrieve data from the non-volatile memory 140 based on the N sets (see boxes 314, 316, and 318 in FIG. 4), and then prefetch a part or all of the retrieved data to the cache 120 (see box 320 in FIG. 4).

Specifically, each set of the M sets of data prefetching parameters may include (A) a predicted starting LBA of the data from the non-volatile memory 140 to be prefetched to the cache 120, (B) a predicted I/O size of the data from the non-volatile memory 140 to be prefetched to the cache 120, and (C) a cache hit probability which is the probability of the data corresponding to the predicted starting LBA and the predicted I/O size of said each set being requested by a future data request made by the host 110 (see box 310 in FIG. 4).

To select the N sets from the M sets, the controller 130 may select sets of the M sets whose cache hit probabilities exceed a pre-specified probability threshold resulting in the N sets being selected from the M sets (see box 312 in FIG. 4).

To retrieve data from the non-volatile memory 140 based on the N sets, for each set of the N sets, the controller 130 may retrieve data from the non-volatile memory 140 based on the predicted starting LBA and the predicted I/O size of said each set (see boxes 314, 316, and 318 in FIG. 4).

### Flowchart Generalizing the Operation of Controller 130

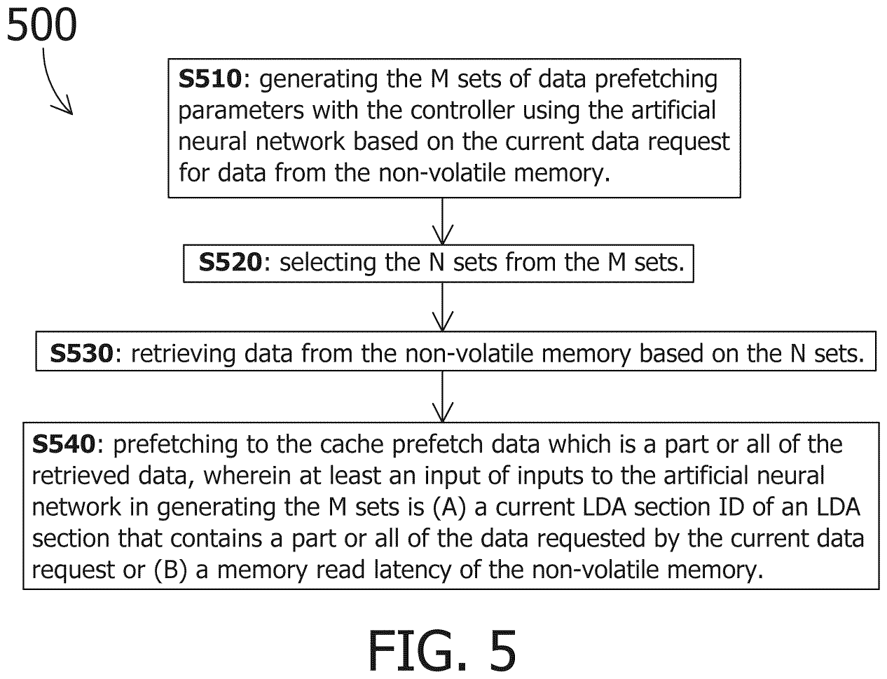

FIG. 5 is a flowchart 500 generalizing the cache prefetching operation, according to an embodiment.

In step S510, the operation may include generating the M sets of data prefetching parameters with the controller using the artificial neural network based on the current data request for data from the non-volatile memory, with M being a positive integer. For example, in the embodiments described above, with reference to FIG. 1-FIG. 4, the controller 130 uses the artificial neural network to generate the M sets of data prefetching parameters based on the current data request for data from the non-volatile memory 140, with M being a positive integer (M=1 corresponds to FIG. 3; and M>1 corresponds to FIG. 4).

In step S520, the operation may include selecting the N sets from the M sets. For example, in the embodiments described above, with reference to FIG. 1-FIG. 4, the controller 130 selects the N sets from the M sets.

In step S530, the operation may include retrieving data from the non-volatile memory based on the N sets. For example, in the embodiments described above, with reference to FIG. 1-FIG. 4, the controller 130 retrieves data from the non-volatile memory 140 based on the N sets.

In step S540, the operation may include prefetching to the cache prefetch data which is a part or all of the retrieved data, wherein at least an input of inputs to the artificial neural network in generating the M sets is (A) a current LDA section ID of an LDA section that contains a part or all of the data requested by the current data request or (B) a memory read latency of the non-volatile memory. For example, in the embodiments described above, with reference to FIG. 1-FIG. 4, the controller 130 prefetches a part or all of the retrieved data to the cache 120, wherein at least an input of inputs to the artificial neural network in generating the M sets is (A) a current LDA section ID of an LDA section that contains a part or all of the data requested by the current data request or (B) the memory read latency of the non-volatile memory 140.

### Other Embodiments

### ZNS Support

With reference to FIG. 1-FIG. 4, the memory subsystem 130+140 may support zoned namespace (ZNS). As a result, in the generation of the M sets of data prefetching parameters (M is a positive integer, with M=1 corresponding to FIG. 3, and M>1 corresponding to FIG. 4), the inputs to the artificial neural network may include the zone ID associated the current data request.

### FDP Support

With reference to FIG. 1-FIG. 4, the memory subsystem 130+140 may support flexible data placement (FDP). As a result, in the generation of the M sets of data prefetching parameters (M is a positive integer, with M=1 corresponding to FIG. 3, and M>1 corresponding to FIG. 4), the inputs to the artificial neural network may include the placement identifier and the namespace ID associated with the current data request.

### Controller Functions

With reference to FIG. 1-FIG. 4, the LBA-to LDA converter 314 (FIG. 3 and FIG. 4) may be part of the controller 130.

With reference to FIG. 1-FIG. 4, the LDA-to-PDA converter 316 (FIG. 3 and FIG. 4) may be part of the controller 130.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A controller, configured to:
generate M sets of data prefetching parameters using an artificial neural network based on a current data request for data from a non-volatile memory, with M being a positive integer,
select N sets from the M sets, with N being a non-negative integer not greater than M,
retrieve data from the non-volatile memory based on the N sets, and
prefetch to a cache prefetch data which is a part or all of the retrieved data,
wherein at least an input of inputs to the artificial neural network in generating the M sets is (A) a current LDA (logical data unit address) section ID (identification) of an LDA section that contains a part or all of the data requested by the current data request or (B) a memory read latency of the non-volatile memory.

2. The controller of claim 1, wherein each set of the M sets of data prefetching parameters comprises:
a predicted starting LBA (Logical Block Address); and
a predicted I/O (input/output) size.

3. The controller of claim 1, wherein M=N=1.

4. The controller of claim 1,
wherein M>1, and
wherein the controller is configured to select the N sets from the M sets by:
causing the artificial neural network to generate for each set of the M sets a cache hit probability of data corresponding to said each set being requested by a future data request; and
selecting sets of the M sets whose cache hit probabilities exceed a pre-specified probability threshold resulting in the N sets being selected from the M sets.

5. The controller of claim 1, configured to implement the artificial neural network in generating the M sets of data prefetching parameters.

6. The controller of claim 1, wherein the non-volatile memory is a flash memory.

7. The controller of claim 1, wherein the artificial neural network is a feed-forward neural network, a reinforcement learning network, a long short-term memory network, a recurrent neural network, a transformer model, or any combinations thereof.

8. The controller of claim 1, wherein the controller is on a single semiconductor die.

9. The controller of claim 1, wherein the inputs to the artificial neural network are selected from a group consisting of:
a current application ID of an application that makes the current data request,
the current LDA section ID,
a current starting LBA of the data requested by the current data request,
a current I/O size of the data requested by the current data request,
the memory read latency of the non-volatile memory, and
any combinations thereof.

10. The controller of claim 1, wherein the inputs to the artificial neural network are selected from a group consisting of:
a current application ID of an application that makes the current data request,
the current LDA section ID,
a current starting LBA of the data requested by the current data request,
a current I/O size of the data requested by the current data request,
the memory read latency of the non-volatile memory,
a zone ID associated with the current data request,
a placement identifier associated with the current data request,
a namespace ID associated with the current data request, and
any combinations thereof.

11. The controller of claim 1, comprising:
an LBA to LDA converter configured to convert an LBA into an LDA of the non-volatile memory; and
an LDA to PDA (physical data address) converter configured to convert an LDA into a PDA of the non-volatile memory.

12. The controller of claim 1, configured to determine if the cache contains data requested by the current data request.

13. The controller of claim 1, wherein an LDA space of the non-volatile memory comprises non-overlapping LDA sections of different sizes.

14. The controller of claim 1, wherein the cache is part of a solid-state drive (SSD) that comprises the controller.

15. The controller of claim 14, wherein the cache is part of the controller.

16. A system, comprising the controller of claim 1, wherein the system is a solid-state drive (SSD), a flash drive, a mother board, a processor, a computer, a server, a gaming device, or a mobile device.

17. A method of using the controller of claim 1, comprising:
generating the M sets of data prefetching parameters with the controller using the artificial neural network based on the current data request for data from the non-volatile memory;
selecting the N sets from the M sets;
retrieving data from the non-volatile memory based on the N sets; and
prefetching to the cache prefetch data which is a part or all of the retrieved data,
wherein at least an input of inputs to the artificial neural network in generating the M sets is (A) a current LDA section ID of an LDA section that contains a part or all of the data requested by the current data request or (B) a memory read latency of the non-volatile memory.

18. The method of claim 17, wherein each set of the M sets of data prefetching parameters comprises:
a predicted starting LBA; and
a predicted I/O size.

19. The method of claim 17, wherein M=N=1.

20. The method of claim 17,
wherein M>1, and
wherein said selecting the N sets from the M sets comprises:
causing the artificial neural network to generate for each set of the M sets a cache hit probability of data corresponding to said each set being requested by a future data request; and
selecting sets of the M sets whose cache hit probabilities exceed a pre-specified probability threshold resulting in the N sets being selected from the M sets.
